(19) United States
(12) Patent Application Publication
(10) Pub. No.: US 2021/0334240 A1
(43) Pub. Date: Oct. 28, 2021

(54) Method and System for VMS-Agnostic Cloud Recording Over Noisy Broadband

(71) Applicant: Rasilient Systems, Inc., Santa Clara, CA (US)

(72) Inventors: Yee-Hsiang Sean Chang, Cupertino, CA (US); Xianyu Rain Wang, Shanghai (CN)

(21) Appl. No.: 17/215,272

(22) Filed: Mar. 29, 2021

Related U.S. Application Data
(60) Provisional application No. 63/016,177, filed on Apr. 27, 2020.

(51) Int. Cl. G06F 16/182; G06F 16/16; G06F 16/178; G06F 16/41; G06F 16/48

(52) U.S. Cl. CPC G06F 16/183; G06F 16/164; G06F 16/48; G06F 16/41; G06F 16/1794

(57) ABSTRACT

A video management storage system for cloud storage is disclosed. The storage system comprises at least one video camera configured to record video, a recording gateway coupled to the cloud storage and the at least one video camera configured to store the record video in a first folder, wherein the recording gateway includes a video management storage archiver configured to perform a file to many object conversion of the record video from the first folder to a second folder and retains a meta-data object mapping file of the file to many object conversion before transferring the many objects to the cloud storage.

### CROSS REFERENCE

This application claims priority from a provisional patent application entitled “Method and Apparatus for VMS-Agnostic Cloud Recording Over Noisy Broadband” filed on Apr. 27, 2020 and having an Application No. 63/016,177. Said application is incorporated herein by reference.

### FIELD OF INVENTION

This invention relates to methods and systems for storing and accessing video surveillance in a data storage system and, in particular, to methods and systems for storing and accessing video in agnostic cloud recording over noisy broadband.

### BACKGROUND

IP cameras, in general, compress their video using H.264/H.265 standards and transmit them over the network. The video is often streaming, meaning the video is recorded continuously and never stops. Although each VMS (video management storage) may record and organize its video differently, most systems break up a continuous video stream into multiple files. For essentially all cameras, the VMS typically breaks every camera stream into increments every few minutes. The VMS generally uses a file system hierarchy to manage all the files based on camera, date, hour, and minute. For example, one IP camera can be set to have a primary folder. Within the primary folder, there may be a set of sub-folders for the dates of the retention. Within the dates folder, there may be a set of sub-folders for every 24 hours. Within an hour sub-folder, there may be files for minutes of recording, etc.

Generally, a VMS also provides for video searching features. A simplest search can be via date. If for example, the video searching feature includes search inputs for a particular time (date, hour, minute), a user can retrieve a specific targeted video. In order to support the video searching feature, when original video streams are being segmented, the VMS updates a video database for the video data. FIG. 1 illustrates a prior art video management storage system interaction with its recording database and cameras. The VMS includes a plurality of cameras coupled to a camera network having a recording gateway to store recordings of videos to a database of recorded video data. The recording gateway includes a database synch to update the database of the recorded videos for later retrieval.

As video recording to the cloud becomes more and more popular in video surveillance, a recording gateway is commonly used in remote offices as a gateway to send the recorded video data to the cloud. A recording gateway provides flexibility to keep the recorded video data which may be critical video longer in the cloud for further review and extended backup.

In order to store the video data, the traditional block and file storage has limitations for its inability to easily scale to the cloud. In block storage, users must partition the contents of the stored data into blocks as defined by the block storage. The term “users” is used loosely to represent applications, plug-ins, or drivers at the edge of a recording gateway for accessing the cloud storage. The users have to be knowledgeable and be able to obtain the information of free block addresses for assignment to the blocks. In other words, the users have to know low-level block information. An example of block storage is iSCSI, small computer system interface (“SCSI”), internet SCSI (“iSCSI”).

Another storage technique for storing data is the use of file storage. In file storage, users must have the information about the file system structure. Once the file system structure is known, users have to decide where the files are going to be written in the file system hierarchy. Users also need to manage the file systems for their contents. For example, only they can copy files from one location to another in the file system. An example of file storage is NFS/CIFS (Network File System/Common Internet File System).

Object storage is another storage technique for storing data. To use object storage, users merely send the contents to the storage. There is neither the concept of block and its address associated with block storage techniques, nor file system hierarchy associated with file storage techniques. In object storage, once the data is stored, the objects can be duplicated, migrated, and other operations can be performed without the users' knowledge. To summarize, users must know the underlying storage structure in order to use block storage and file storage techniques. For object storage, there is no need for the user to know the underlying storage structure. For this reason, object storage techniques can be the most usable and scalable over block storage and file storage techniques.

FIG. 2 shows a prior art example of a file-to-object mapping. There are 5 variously sized files that are in their native file sizes. File 4 is the smallest sized file and file 5 is the largest sized file. File 1 and file 2 are located in a first folder 1, and file 3, file 4, and file 5 are located in a second folder 2. Using today's file to object mapping technique, each file is mapped to one object or one-to-one correspondence. However, the transport mechanism is still naturally based on files rather than objects and follows the same folder hierarchical structure with the files inside the same folder being transmitted in sequence. In this case, files in folder 1 are transmitted in sequence with file 1 followed by file 2. Next, files in folder 2 are transmitted in sequence with file 3 followed by file 4 and finally file 5.

Generally, cloud recording is typically confined to a particular VMS. For recording systems having an existing VMS without a cloud recording feature, these systems may need to change the VMS and their associated infrastructure. However, the cloud recording feature is fundamentally based on the Internet using the TCP/IP protocol. TCP or transmission control protocol is developed for the internet to get data from one network device to another for end-to-end transmission, and IP is for internet working. TCP is a stateful protocol which generally means each end maintains the states of the session. Any troubles with the session such as packet drops or timeouts require the states to get synched up from both ends of the transfer protocol before proceeding with a transfer. For long distance communications such as across the Pacific Ocean, the synchronization can take multiple round trips and a very long time.

TCP congestion control algorithms are “polite,” meaning the session would stop transmission upon drops to avoid further congestion, and wait for end-to-end information to resume but slowly. Such delays are not ideal for 24×7×365 streaming recording video.

Wireless networks present even more challenges. Wireless signal strength is well known for its varying signal strength within a cell and disruption across cells. The disruptiveness of wireless signal strength is even more challenging if the recording is from a bus or train where movement and the speed of the vehicle can further amplify the impacts.

Besides network congestion and synchronizations delays through long-distances, some country-wide firewalls can such as China create additional problems. In such situations, the TCP/IP protocol traffic would be touted for deeper analysis due to potential censorship. The additional deeper analysis adds further delay and even loss of potential transmitted video data. Firewalls are notorious for preventing large file transfers and causing breaks in continuous video transmissions.

The TCP stateful problem is well known. However, the TCP/IP protocol is ubiquitous and used throughout the worldwide. A solution has been to use the CDN (Content Distribution Network) technology which is used by almost all major public cloud providers. The CDN technology provides a solution that requires the cloud datacenters everywhere to be close to the end users. Accordingly, every major city has one or more cloud data centers.

However, the CDN technology is expensive and very restrictive. Moreover, many enterprise customers do not trust using a public cloud to keep their videos, but rather record all videos to their own world wide headquartered private cloud.

Accordingly, it is desirable to provide methods and systems to overcome storage scalability and the TCP/IP stateful communication problem over long distance using unreliable congested networks.

### SUMMARY OF INVENTION

In accordance to an embodiment of the present invention, a video management storage system for cloud storage is disclosed. The video management storage system comprises at least one video camera configured to record video, a recording gateway coupled to the cloud storage and the at least one video camera configured to store the record video in a first folder, wherein the recording gateway includes a video management storage archiver configured to perform a file to many object conversion of the record video from the first folder to a second folder and retains a meta-data object mapping file of the file to many object conversion before transferring the many objects to the cloud storage.

In accordance to another embodiment of the present invention, the record video in the first folder includes a plurality of video files, and the meta-data object mapping file includes an unique name and mapping information for a video file of the plurality of video files.

In yet another embodiment of the present invention, the meta-data object mapping file includes a first object configured to store meta-data for the mapping information for the many objects of the video file.

In a further embodiment of the present invention, the first folder includes a database for the record video.

In yet another embodiment of the present invention, the second folder includes at least one meta-data object mapping file and a plurality objects associated with the one meta-data object mapping file.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a prior art video management system interaction with its recording database and cameras;

FIG. 2 illustrates a prior art example of a file-to-object mapping;

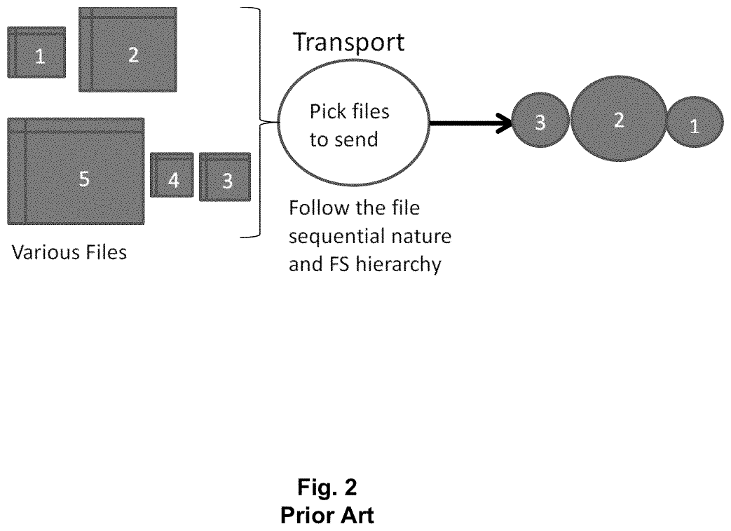

FIG. 3 illustrates a cloud recording system in accordance to the present invention;

FIG. 4 illustrates a files-to-object conversion of various sized files in accordance to the present invention;

FIG. 5 illustrates an example file structure for a file-to-object mapping with a meta-data object in accordance to the present invention;

FIG. 6 illustrates a flow chart showing the creation of the one-to-many objects mapping in accordance to the present invention; and

FIG. 7 illustrates an object transport state diagram to dynamically adjust a number of outstanding objects for creation of one-to-many object mapping of video data for transfer in accordance to the present invention.

### DETAILED DESCRIPTION OF THE PREFERRED EMBODIMENTS

Cloud recording is becoming popular in video surveillance. In cloud recording, a recording gateway is used in remote offices to record the video to the cloud. Recording to the cloud can provide advantages of less on-site maintenance, higher reliability, and wider accessibility.

Today, cloud recording is generally tied to a particular VMS (Video Management Storage). People having existing VMS without a cloud recording feature would need to change their VMS and its associated infrastructure. However, cloud recording infrastructure can be adapted to many existing VMS with minor modifications.

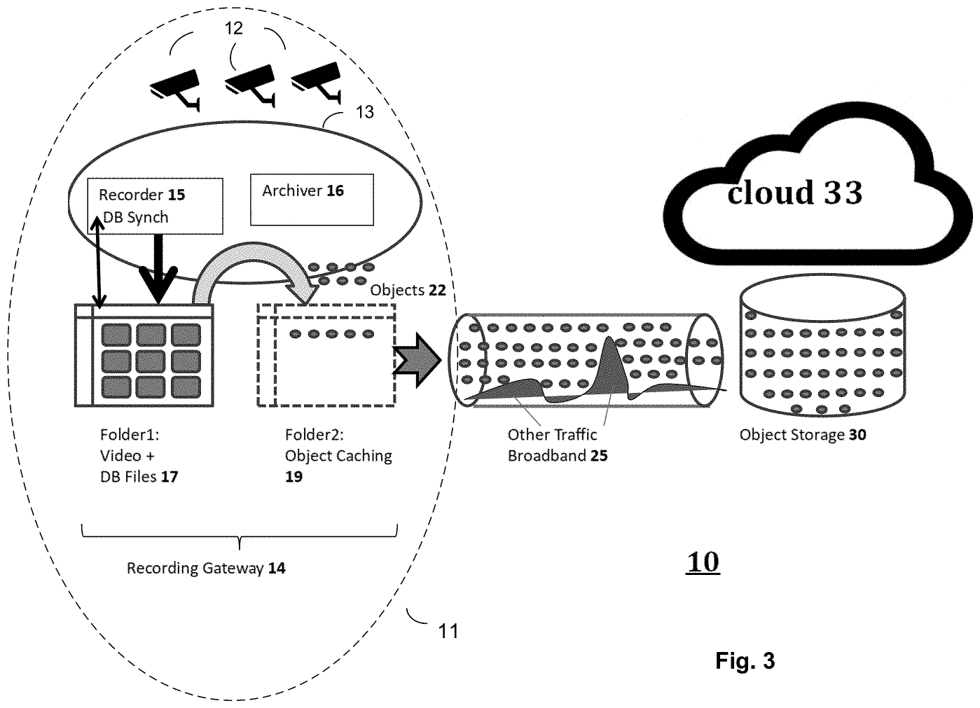

FIG. 3 illustrates a VMS system 10 in accordance to the present invention. The VMS system 10 can support any VMS for recording video to the cloud. In general, a VMS comprises recording infrastructure that is typically local to the cameras as opposed to the cloud that can reside almost anywhere. Instead of recording video data from a VMS directly to the cloud, the present invention decouples the close interaction between a VMS, the recorded video data, and the associated database before sending the video data to the cloud for recording. The VMS system 10 for recording video to the cloud includes a least one camera 12, a recording network 13, a recording gateway 14, broadband connection 25, object storage 30, and cloud storage 33.

A VMS 11 on the other hand is generally local and includes the at least one camera 12, the recording network 13, and the recording gateway 14. The recording gateway 14 includes a video management storage recorder 15 and a video management storage archiver 16. The video management storage recorder 15 handles database synching and records to a first folder 17 for local storage of recorded video. The first folder 17 resides on the local storage and includes video files and related database files. Depending on the implementation, the first folder 17 can be a hidden folder. In accordance to an embodiment of the present invention, Windows NTFS (New Technology File System) VHD (Virtual Hard Drive) can be used. Under Windows NTFS VHD, the first folder 17 is an invisible folder to the users. The video management storage recorder 15 of the VMS 11 records to the first folder 17 for short term retention.

The VMS 11 includes a built-in VMS archiver 16 that moves the video from the first folder 17 to a second folder 19 for longer video retention. The second folder 19 is a virtual folder having its contents residing in a cloud 33. The recording gateway 14 includes resources from the VMS archiver 16 that converts the video files to a large number of small objects. The VMS archiver 16 sends the small objects 22 concurrently and independently using independent TCP sessions over the broadband connection 25. The broadband connection 25 can often times be noisy networks. The objects 22 are ultimately transferred and placed in object storage 30 within the cloud 33. With the conversion of the video files into so many small objects which can number in the hundreds, the many small objects ensure higher probability of getting the data through over noisy broadband conditions.

The VMS archiver 16 of the VMS 11 uses two folders to decouple the recorded video and its database files. More specifically, the VMS archiver 16 treats the first folder as a legitimate location for video recording with a specific recording period such as 24 hours. Accordingly, the videos recorded from the at least one camera 12 is recorded and stored in the first folder 17. For extended video retention such as 30 days, the VMS archiver 16 moves the video to the second folder 19. There is no synchronization with the contents once the video is moved to the archive second folder 19 which is actually part of cloud 33. Almost all current video management storage systems include an archiving feature to support extended retention externally using block or file storage (e.g., NAS or SAN).

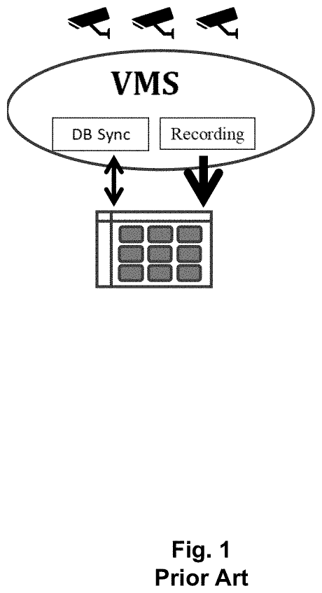

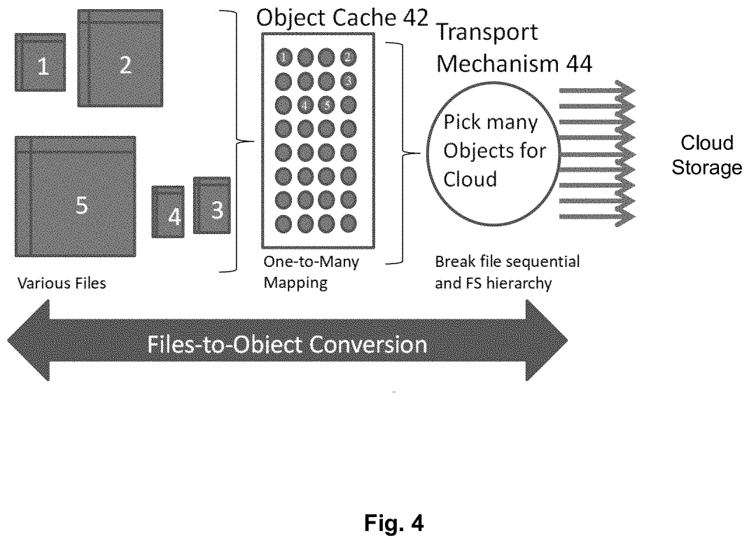

FIG. 4 illustrates a files-to-object conversion of various sized files in accordance to the present invention. There are 5 files of various sizes: file 1, file 2, file 3, file 4, and file 5. File 5 is the largest of the 5 files. In contrast with the prior art FIG. 1 example of one-to-one mapping that is generally used in other cloud object storage applications, the VMS archiver 16 creates a mapping of one-to-many objects mapping for each of the 5 files. For example, each file may be mapped into 50 objects. The VMS archiver 16 also creates a meta-data object mapping file that corresponds with the many object conversion that includes the mapping information for the 50 objects. The meta-data object mapping file is a first object of the plurality of objects. Accordingly, there are a total of 51 objects corresponding to the one-to-many mapping that are placed in an object cache 42 for transport to the cloud.

The transport mechanism 44 picks the many objects from the object cache 42 and sends the many object to the cloud for storage. The one-to-many mapping of each file breaks the file sequential and file system hierarchy relationship of each file. In accordance to the present invention, the VMS archiver 16 maintains a copy of the first object of the meta-data object mapping file for each file in a local cache so a video management storage reconstructor that is part of the VMS archiver 16 can readily reconstruct the original file from retrieving the objects from the cloud storage.

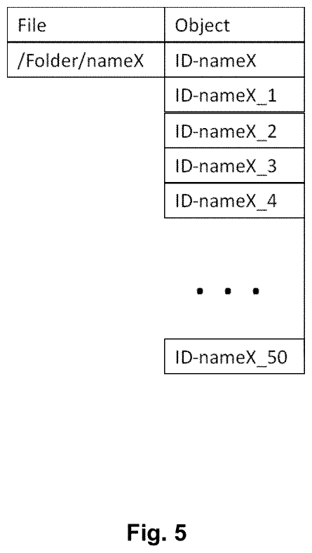

FIG. 5 illustrates an example file structure for a file-to-object mapping with a meta-data object in accordance to the present invention. A File designation provides nameX as file name and location of folder. An Object designation provides a first object ID-nameX that is associated with a meta-data object and includes mapping information for the many objects that follow. In the FIG. 5 example, there are 50 objects associated with the file nameX in addition to the first object ID-nameX that contains the mapping information for the many objects for a total of 51 objects. In accordance with the present invention, more than 50 objects may be used depending on severity of the network congestion.

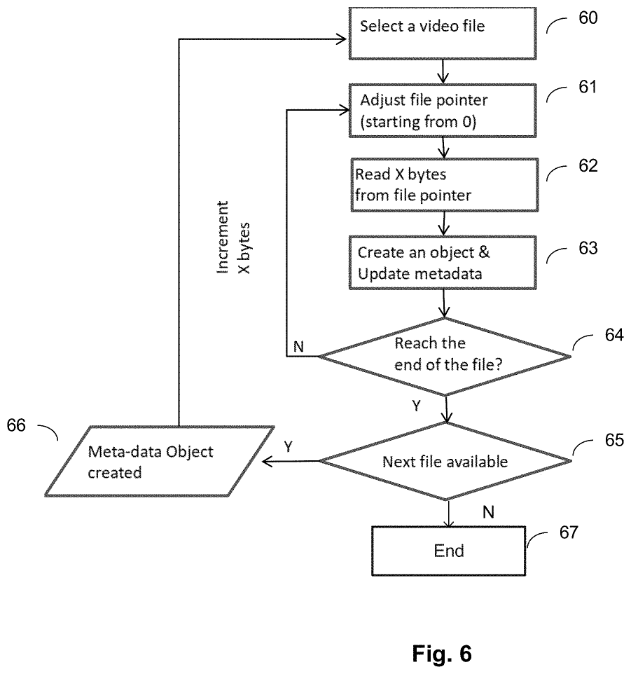

FIG. 6 illustrates a flow chart showing the creation of the one-to-many objects mapping in accordance to the present invention. The flow chart begins with step 60 select a video file. Next, in step 61, adjust file pointer starting from 0. Step 62 reads X bytes from the file pointer. Next, in step 63, create an object based upon the X bytes from the file pointer and update meta-data. The flow chart moves to the next decision step 64. In decision step 64, an inquiry if reach the end of the file? If not, increment X bytes and return to step 61. If decision step 64, the inquiry reach end of the file is a Yes, then the flow chart moves to another decision step 65. In decision step 65, is next file available? If yes, the flow chart moves to step 66 meta-data object created, and the flow chart returns to step 60. If in decision step 65, there is not a next file available, then the flow chart ends in step 67. A plurality of objects is created using the one-to-many objects mapping flow chart in accordance to the present invention

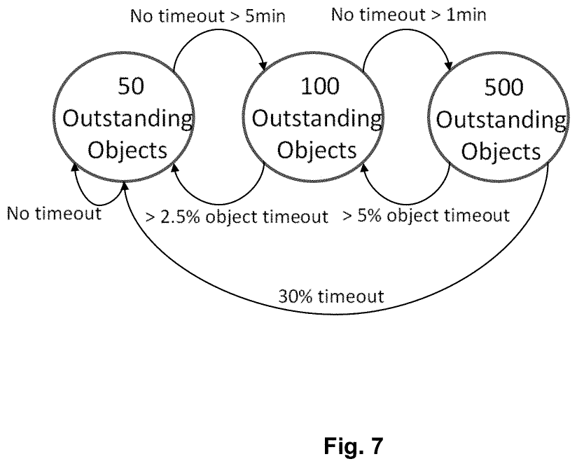

FIG. 7 illustrates an object transport state diagram to dynamically adjust a number of outstanding objects for creation of the one-to-many object mapping of video data for transfer to the cloud in accordance to the present invention. Since each object transfer still uses TCP, the one-to-many objects mapping reduces the impact of TCP stateful issue that occurs. A commonly implemented timeout mechanism that is used in many communication protocols can be leveraged to terminate sessions and retransmit any troubled objects. In operation, an implemented timeout mechanism is started when a sender sends a message. If a response is not received before the timeout mechanism expires, the sender or recording gateway can take necessary action which in this case can be to terminate the session and transmit the object. A timeout mechanism is particularly important when a receiver is not intelligent or far away requiring responses that takes a long time to synchronize.

Referring to FIG. 7, a number of outstanding objects of a file can be dynamically adjusted to be 50, 100, or 500 objects, although other numbers of outstanding objects may be used. For simplicity, the present example does not dynamically change the object size, but those skilled in art realize that such implementation is still within the purview of the present invention. When the recording gateway of a cloud recording system observes too many timeouts, e.g., >30%, the recording gateway will reduce the outstanding object number back to the lowest one at 50 outstanding objects to reduce network congestion. Moreover, if greater than 2.5% of objects sent timeout, then the outstanding objects may be decreased from 100 outstanding objects to 50 outstanding objects. Alternatively, if there have been no timeouts for greater than 5 minutes, the number of outstanding objects may be increased from 50 outstanding objects to 100 outstanding objects.

In order to deal with noisy broadband, the present invention creates a large number of independent objects. Each object can be transmitted and dropped independently due to congestion without affecting the other objects. With a large number of objects, even conditions of large packet drop such as 10%, consistent performance can still be maintained. Equating the small object size to the packet size, a 10% packet lost means 90% of the packets are able to get through and only 10% of the packets is required to be retransmitted. The larger the number of objects is in the network, the higher the efficiency will be over the noisy broadband.

While the present invention has been described with reference to certain preferred embodiments or methods, it is to be understood that the present invention is not limited to such specific embodiments, methods, or systems. Moreover, cloud based recording systems are not just limited to video surveillance; cloud based recording systems enable users to capture, record, encrypt, and store all interactions within a business and between employees and clients whether the interaction is through video, landline, mobile, email, SMS or fax. Rather, it is the inventor's contention that the invention be understood and construed in its broadest meaning as reflected by the following claims. Thus, these claims are to be understood as incorporating not only the preferred systems and methods described herein but all those other and further alterations and modifications as would be apparent to those of ordinary skilled in the art.

1. A video management storage system for cloud storage comprising:
at least one video camera configured to record video;
a recording gateway coupled to the cloud storage and the at least one video camera configured to store the record video in a first folder, wherein the recording gateway includes a video management storage archiver configured to perform a file to many object conversion of the record video from the first folder to a second folder and retains a meta-data object mapping file of the file to many object conversion before transferring the many objects to the cloud storage.

2. The video management storage system for cloud storage of claim 1, wherein the record video in the first folder includes a plurality of video files; and
the meta-data object mapping file includes an unique name and mapping information for a video file of the plurality of video files.

3. The video management storage system for cloud storage of claim 2, wherein the meta-data object mapping file includes a first object configured to store meta-data for the mapping information for the many objects of the video file.

4. The video management storage system for cloud storage of claim 3, wherein the first object of the meta-data object mapping file is cached at the recording gateway.

5. The video management storage system for cloud storage of claim 1, wherein the first folder includes a database for the record video.

6. The video management storage system for cloud storage of claim 1, wherein the second folder includes at least one meta-data object mapping file and a plurality objects associated with the one meta-data object mapping file.

7. The video management storage system for cloud storage of claim 6, wherein there are 50 objects associated with the one meta-data object mapping file.

8. The video management storage system for cloud storage of claim 7, wherein the meta-data mapping file is a first object associated with the plurality objects of the meta-data mapping file.

9. The video management storage system for cloud storage of claim 8, wherein the plurality of objects of the meta-data mapping file are transferred concurrently using independent TCP sessions.

10. The video management storage system for cloud storage of claim 9, wherein:
the video management storage archiver includes a timeout mechanism configured to receive an acknowledgment receipt of the plurality objects of the meta data mapping file from the cloud storage; and
the video management storage archiver in response to the acknowledgement receipt dynamically adjust a number of objects associated with the one meta-data object mapping file.

11. The video management storage system for cloud storage of claim 10, wherein the video management storage archiver adjusts the number of objects associated with the one meta-data object mapping file to 100 objects or 500 objects in response to a number of timeouts received within a predetermined time period.

12. The video management storage system for cloud storage of claim 1, wherein the video management storage archiver includes a video management storage reconstructor configured to retrieve the first object of a meta-data object mapping file associated with a plurality of objects received from the cloud storage and reassembles the many objects to reconstruct the record video.

13. A video management storage system for cloud storage comprising:
at least one video camera configured to record video;
a recording gateway coupled to the cloud storage and the at least one video camera configured to store the record video in a first folder, wherein the recording gateway includes:
a video management storage archiver configured to perform a file to many object conversion of the record video from the first folder to a second folder and retains a meta-data object mapping file of the file to many object conversion and transfers the many objects to the cloud storage; and
a video management reconstructor configured to retrieve the meta-data object mapping file of the file to many object conversion and reconstruct the record video from retrieving the many objects associated with the meta-data object mapping file from the cloud storage.

14. The video management storage system for cloud storage of claim 13, wherein the meta-data object mapping file includes a first object configured to store meta-data for the mapping information for the many objects of the video file.

15. The video management storage system for cloud storage of claim 14, wherein the first object of the meta-data object mapping file is cached at the recording gateway.

16. A method for operating a video management storage system for cloud storage comprising the steps of:
configuring at least one video camera to record video;
storing the record video in a first folder at a recording gateway coupled to the cloud storage; and
performing a file to many object conversion of the record video at a video management storage archiver of the recording gateway from the first folder to a second folder while retaining a meta-data object mapping file of the file to many object conversion before transferring the many objects to the cloud storage.

17. The method for operating a video management storage system for cloud storage of claim 16 further comprising the steps of configuring a timeout mechanism coupled to the video management storage archiver to receive an acknowledgment receipt of the plurality objects of the meta data mapping file from the cloud storage, wherein based upon a timing of the acknowledgement receipt, dynamically adjust a number of objects associated with the one meta-data object mapping file.

18. The method for operating a video management storage system for cloud storage of claim 17 further comprising the steps of dynamically increasing a number of objects associated with the one meta-data object mapping file in response to receiving the acknowledgement receipt within a predetermined time.

19. The method for operating a video management storage system for cloud storage of claim 17 further comprising the steps of dynamically decreasing a number of objects associated with the one meta-data object mapping file in response to receiving the acknowledgement receipt outside a predetermined time.

20. The method for operating a video management storage system for cloud storage of claim 17 further comprising the steps of dynamically decreasing a size of each of the number of objects associated with the one meta-data object mapping file in response to receiving the acknowledgement receipt within a predetermined time.
